(19) United States
(12) Patent Application Publication
(10) Pub. No.: US 2022/0300684 A1
(43) Pub. Date: Sep. 22, 2022

(54) Modelling Annular Stratified Flow

(71) Applicant: Schlumberger Technology Corporation, Sugar Land, TX (US)

(72) Inventors: Dag BIBERG, Asker (NO); Aron ANDERSSON, Menlo Park, CA (US); Alexandre BRIGADEAU, Asker (US)

(21) Appl. No.: 17/596,226

(22) PCT Filed: Jun. 4, 2020
(86) PCT No.: PCT/US2020/036074

§ 371 Date: Dec. 6, 2021

Related U.S. Application Data
(60) Provisional application No. 62/857,023, filed on Jun. 4, 2019.

(51) Int. Cl. G06F 30/28

(52) U.S. Cl. CPC G06F 30/28; G06F 2113/08

(57) ABSTRACT

Methods and systems for modelling annular multiphase fluid flows in a structure are disclosed. In one example, a method is disclosed that includes determining a liquid velocity distribution for a liquid component the multiphase fluid flow; determining a gas velocity distribution for a gas component of the multiphase fluid flow; determining a film roughness between the liquid and gas components at least in part by balancing gravity forces and turbulent stresses so that asymmetry in the fluid flow increases as a deviation of the structure from a first direction; and generating a fluid flow model based in part on the liquid and gas velocity distributions and the film roughness.

### CROSS REFERENCE

This application claims the benefit of U.S. Provisional Patent App. No. 62/857,023, Modelling Annular Stratified Flow,” filed 4 Jun. 2019, the disclosure of which is hereby incorporated herein by reference.

### BACKGROUND

Annular stratified flow may occur in pipeline transport of gas-condensate fluids at high rates. One difference between pure stratified flow and annular stratified flow is that the latter includes a thin film of liquid between the gas and the pipe wall, which is held in place by the turbulent fluctuations. The thin film can become very rough, increasing the frictional contribution to the pressure gradient, particularly for flows with low liquid loading, where other contributions to the pressure gradient are relatively small.

Three-phase data has revealed an additional pressure drop that was not predicted by current stratified flow model. Further, present models were designed for vertical flow, which is axisymmetric on average, with the thin film distributed uniformly in an annular layer around the pipe wall. Additionally, the current two-phase flow model was extended to three-phase flow in a simple way. Specifically, the liquids were assumed to be perfectly mixed, giving an equivalent two-phase gas-liquid flow with liquid properties determined by relatively simple mixture models.

### SUMMARY

Methods, computing systems, and non-transitory computer-readable media are disclosed. For example, the method may include determining a liquid velocity distribution for a liquid component of an annular, multiphase fluid flow in a pipe, determining a gas velocity distribution for a gas component of the annular, multiphase fluid flow, determining a film roughness between the liquid and gas components at least in part by balancing gravity forces and turbulent stresses so that asymmetry in the fluid flow increases as a deviation of the pipe from vertical increases, and generating a fluid flow model based in part on the liquid and gas velocity distributions and the film roughness.

It will be appreciated that this summary is intended merely to introduce some aspects of the present methods, systems, and media, which are more fully described and/or claimed below. Accordingly, this summary is not intended to be limiting.

### BRIEF DESCRIPTION OF THE DRAWINGS

The accompanying drawings, which are incorporated in and constitute a part of this specification, illustrate embodiments of the present teachings and together with the description, serve to explain the principles of the present teachings. In the figures:

FIG. 1 illustrates an example of a system that includes various management components to manage various aspects of a geologic and/or pipeline environment, according to an embodiment.

FIG. 2 illustrates an annular stratified flow with a thin liquid film between the gas core and the pipe wall.

FIG. 3 illustrates a friction factor for gravity-controlled flow

FIG. 4 illustrates a mixture viscosity (left) and surface tension (right), with plots for pure water and water with glycerol.

FIG. 5 illustrates overall performance of the model; comparison of predicted and measured values of the pressure drop. Top left: gas-oil data. Top right: gas-water data. Bottom left: gas-water+glycerol data. Bottom right: two- and three-phase data with and without glycerol. Grey shading indicates ±20% error bounds. Dashed lines indicate P80 error bounds.

FIG. 6 illustrates gas-oil data: trend plots of measured values (dots) and predicted values (lines) as a function of superficial gas velocity (top row) and superficial liquid velocity (bottom row). Left column pressure gradient. Right column liquid line fraction.

FIG. 7 illustrates gas-water data: trend plots of measured values (dots) and predicted values (lines) as a function of superficial gas velocity (top row) and superficial liquid velocity (bottom row). Left column pressure gradient. Right column line fraction.

FIG. 8 illustrates gas-water-glycerol data: trend plots of measured values (dots) and predicted values (lines) as a function of superficial gas velocity (top row) and superficial liquid velocity (bottom row). Left column pressure gradient. Right column line fraction.

FIG. 9 illustrates gas-oil-water data: trend plots of measured and predicted values of pressure drop as a function of water cut. Left near-horizontal flow (8-in pipe); right vertical flow (4-in pipe).

FIG. 10 illustrates three-phase data: trend plots of measured values (dots) and predicted values (lines) of pressure gradient as a function of water cut. Left gas-oil-water data; Right: gas-oil-water-glycerol data.

FIG. 11 illustrates a flowchart of a method for modelling fluid flow, according to an embodiment.

FIG. 12 illustrates a schematic view of a computing system, according to an embodiment.

FIG. 13 illustrates a flowchart of a method for modelling fluid flow, according to an embodiment.

### DETAILED DESCRIPTION

Reference will now be made in detail to embodiments, examples of which are illustrated in the accompanying drawings and figures. In the following detailed description, numerous specific details are set forth in order to provide a thorough understanding of the invention. However, it will be apparent to one of ordinary skill in the art that the invention may be practiced without these specific details. In other instances, well-known methods, procedures, components, circuits, and networks have not been described in detail so as not to unnecessarily obscure aspects of the embodiments.

It will also be understood that, although the terms first, second, etc. may be used herein to describe various elements, these elements should not be limited by these terms. These terms are only used to distinguish one element from another. For example, a first object or step could be termed a second object or step, and, similarly, a second object or step could be termed a first object or step, without departing from the scope of the present disclosure. The first object or step, and the second object or step, are both, objects or steps, respectively, but they are not to be considered the same object or step.

The terminology used in the description herein is for the purpose of describing particular embodiments and is not intended to be limiting. As used in this description and the appended claims, the singular forms “a,” “an” and “the” are intended to include the plural forms as well, unless the context clearly indicates otherwise. It will also be understood that the term “and/or” as used herein refers to and encompasses any possible combinations of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Further, as used herein, the term “if” may be construed to mean “when” or “upon” or “in response to determining” or “in response to detecting,” depending on the context.

Attention is now directed to processing procedures, methods, techniques, and workflows that are in accordance with some embodiments. Some operations in the processing procedures, methods, techniques, and workflows disclosed herein may be combined and/or the order of some operations may be changed.

1. Geological and Fluid Flow Modelling Environment

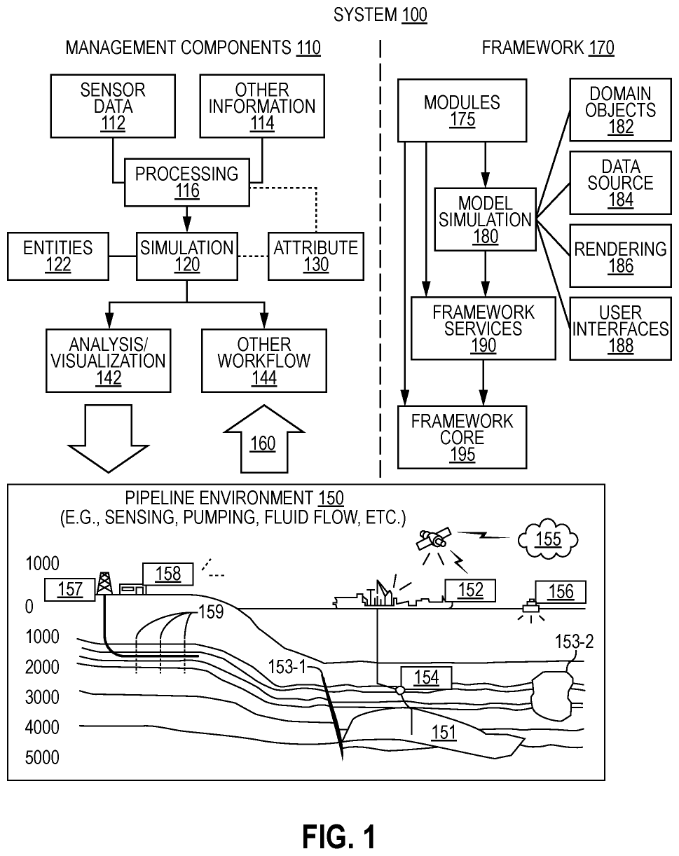

FIG. 1 illustrates an example of a system 100 that includes various management components 110 to manage various aspects of a pipeline environment 150 (e.g., an environment that includes a system of pipes, valves, fittings, etc., which may connected to a geological environment that includes a reservoir 151, one or more faults 153-1, one or more geobodies 153-2, etc.). For example, the management components 110 may allow for direct or indirect management of pipeline activities and structures with respect to the pipeline environment 150. In turn, further information about the pipeline environment 150 may become available as feedback 160 (e.g., optionally as input to one or more of the management components 110).

In the example of FIG. 1, the management components 110 include a sensor data component 112, an additional information component 114 (e.g., component data, geological data, or fluid characteristic data), a processing component 116, a simulation component 120, an attribute component 130, an analysis/visualization component 142 and a workflow component 144. In operation, seismic data and other information provided per the components 112 and 114 may be input to the simulation component 120.

In an example embodiment, the simulation component 120 may rely on entities 122. Entities 122 may include structures or devices such as pipes, fittings, valves, tanks, risers, wells, surfaces, bodies, reservoirs, etc. In the system 100, the entities 122 can include virtual representations of actual physical entities that are reconstructed for purposes of simulation. The entities 122 may include entities based on data acquired via sensing, observation, etc. (e.g., the seismic data 112 and other information 114). An entity may be characterized by one or more properties. Such properties may represent one or more measurements (e.g., acquired data), calculations, etc.

In an example embodiment, the simulation component 120 may operate in conjunction with a software framework such as an object-based framework. In such a framework, entities may include entities based on pre-defined classes to facilitate modelling and simulation. A commercially available example of an object-based framework is the MICROSOFT® .NET® framework (Redmond, Wash.), which provides a set of extensible object classes. In the .NET® framework, an object class encapsulates a module of reusable code and associated data structures. Object classes can be used to instantiate object instances for use in by a program, script, etc. For example, borehole classes may define objects for representing boreholes based on well data.

In the example of FIG. 1, the simulation component 120 may process information to conform to one or more attributes specified by the attribute component 130, which may include a library of attributes. Such processing may occur prior to input to the simulation component 120 (e.g., consider the processing component 116). As an example, the simulation component 120 may perform operations on input information based on one or more attributes specified by the attribute component 130. In an example embodiment, the simulation component 120 may construct one or more models of the geologic environment 150, which may be relied on to simulate behavior of the geologic environment 150 (e.g., responsive to one or more acts, whether natural or artificial). In the example of FIG. 1, the analysis/visualization component 142 may allow for interaction with a model or model-based results (e.g., simulation results, etc.). As an example, output from the simulation component 120 may be input to one or more other workflows, as indicated by a workflow component 144.

As an example, the simulation component 120 may include one or more features of a simulator such as the OLGA™ pipeline simulator (Schlumberger Limited, Houston, Tex.) ECLIPSE™ reservoir simulator (Schlumberger Limited, Houston Tex.), the INTERSECT™ reservoir simulator (Schlumberger Limited, Houston Tex.), etc. As an example, a simulation component, a simulator, etc. may include features to implement one or more meshless techniques (e.g., to solve one or more equations, etc.). As an example, a reservoir or reservoirs may be simulated with respect to one or more enhanced recovery techniques (e.g., consider a thermal process such as SAGD, etc.).

In an example embodiment, the management components 110 may include features of a commercially available framework. Through use of such a framework, various professionals (e.g., geophysicists, geologists, and reservoir engineers) can develop collaborative workflows and integrate operations to streamline processes. Such a framework may be considered an application and may be considered a data-driven application (e.g., where data is input for purposes of modelling, simulating, etc.).

FIG. 1 also shows an example of a framework 170 that includes a model simulation layer 180 along with a framework services layer 190, a framework core layer 195 and a modules layer 175. As an example, a framework may include features for implementing one or more mesh generation techniques. For example, a framework may include an input component for receipt of information from interpretation of pipeline data, one or more attributes based at least in part on sensor data, image data, etc.

In the example of FIG. 1, the model simulation layer 180 may provide domain objects 182, act as a data source 184, provide for rendering 186 and provide for various user interfaces 188. Rendering 186 may provide a graphical environment in which applications can display their data while the user interfaces 188 may provide a common look and feel for application user interface components.

As an example, the domain objects 182 can include entity objects, property objects and optionally other objects. Entity objects may be used to geometrically represent pipes, fittings, valves, wells, surfaces, bodies, reservoirs, etc., while property objects may be used to provide property values as well as data versions and display parameters. For example, an entity object may represent a well where a property object provides log information as well as version information and display information (e.g., to display the well as part of a model).

In the example of FIG. 1, data may be stored in one or more data sources (or data stores, generally physical data storage devices), which may be at the same or different physical sites and accessible via one or more networks. The model simulation layer 180 may be configured to model projects. As such, a particular project may be stored where stored project information may include inputs, models, results and cases. Thus, upon completion of a modelling session, a user may store a project. At a later time, the project can be accessed and restored using the model simulation layer 180, which can recreate instances of the relevant domain objects.

As an example, the pipeline environment 150 may be outfitted with any of a variety of sensors, detectors, actuators, etc. For example, equipment 152 may include communication circuitry to receive and to transmit information with respect to one or more networks 155. Such information may include information associated with equipment 154, which may be equipment to acquire information, to assist with resource recovery, etc. Other equipment 156 may be located remote from a well site and include sensing, detecting, emitting or other circuitry. Such equipment may include storage and communication circuitry to store and to communicate data, instructions, etc. As an example, one or more satellites may be provided for purposes of communications, data acquisition, etc. For example, FIG. 1 shows a satellite in communication with the network 155 that may be configured for communications, noting that the satellite may additionally or instead include circuitry for imagery (e.g., spatial, spectral, temporal, radiometric, etc.).

FIG. 1 also shows the geologic environment 150 as optionally including equipment 157 and 158 associated with a well that includes a substantially horizontal portion that may intersect with one or more fractures 159. For example, consider a well in a shale formation that may include natural fractures, artificial fractures (e.g., hydraulic fractures) or a combination of natural and artificial fractures. As an example, a well may be drilled for a reservoir that is laterally extensive. In such an example, lateral variations in properties, stresses, etc. may exist where an assessment of such variations may assist with planning, operations, etc. to develop a laterally extensive reservoir (e.g., via fracturing, injecting, extracting, etc.). As an example, the equipment 157 and/or 158 may include components, a system, systems, etc. for fracturing, seismic sensing, analysis of seismic data, assessment of one or more fractures, etc.

As mentioned, the system 100 may be used to perform one or more workflows. A workflow may be a process that includes a number of worksteps. A workstep may operate on data, for example, to create new data, to update existing data, etc. As an example, a may operate on one or more inputs and create one or more results, for example, based on one or more algorithms. As an example, a system may include a workflow editor for creation, editing, executing, etc. of a workflow. In such an example, the workflow editor may provide for selection of one or more pre-defined worksteps, one or more customized worksteps, etc.

2. Introduction to the Modelling Methods

As mentioned above, previous models were for vertical flow, which is axisymmetric on average, with the thin film distributed uniformly in an annular layer around the pipe wall. In the present disclosure, a new model is generated, which describe inclined and horizontal flows, where the effect of gravity leads to an asymmetric distribution of the liquid. The degree of asymmetry is determined by a balance of gravity forces and turbulent stresses, so that the asymmetry tends to increase as the deviation of the pipe from the vertical increases, as the gas flow rate decreases or as the liquid flow rate increases.

Further, in the previous models, the basic two-phase flow model was extended to three-phase flow in a simple way; the liquids were assumed to be perfectly mixed, giving an equivalent two-phase gas-liquid flow with liquid properties determined by relatively simple mixture models. In the present disclosure, it is observed that the effect of gravity tends to be stronger for the aqueous phase than for the oil phase, leading to enrichment of the oil fraction in the thin annular film and of the aqueous fraction in the stratified liquid layer, so that a fully homogeneous model can no longer be applied.

3. Annular Stratified Flow

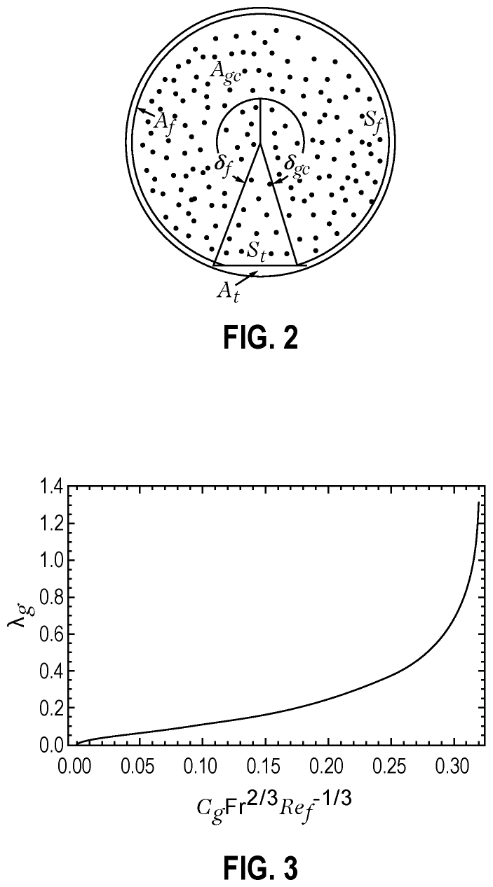

Consider two-phase annular stratified flow with low liquid loading in a straight pipe with inner diameter D, inclined at an arbitrary angle θ above the horizontal. A thin viscous liquid film between the gas core and the pipe wall is maintained by the turbulent fluctuations in the gas. Depending on the flow conditions and the pipe inclination, gravity causes a stratified liquid layer to accumulate in the bottom of the pipe. The interface between the liquid layer and the gas is taken to be flat for simplicity (FIG. 2). The liquid layer and film flow geometry considered here may be conceived as an approximation for the curved interface flow geometry, which is likely to occur in a real flow.

The pressure drop −dp/dx and total liquid holdup ε_{L}=εₗ+ε_{d}+ε_{f}, may be computed where εₗ, ε_{d} and ε_{f} are the liquid holdups in the stratified layer, the droplet field and the thin annular film. The gas and liquid superficial velocities U_{sG} and U_{sL} are specified input. The corresponding mean (bulk) velocities over the gas core and stratified liquid layer flow areas A_{gc} and Aₗ are:

$$\begin{matrix}{U}_{gc} = \frac{{U}_{sG} + {U}_{sd}}{{ε}_{gc}} & ( 1 ) \\ {U}_{l} = \frac{{U}_{sL} - {U}_{sf} - {U}_{sd}}{{ε}_{l}} & ( 2 )\end{matrix}$$

where U_{sd} and U_{sf} are the superficial velocities of the liquid in the droplet field and in the thin film, and ε_{gc}=A_{gc}/A and εₗ=Aₗ/A are the gas core and liquid layer area fractions. Here A=πR² is the pipe (inner) cross sectional area and R=D/2 is the radius.

The liquid droplets may be assumed to be uniformly distributed in the gas and to travel with the gas velocity. The mean density in the gas core is therefore

ρ_{gc}=(1−γ)ρ_{G}+γρ_{d} (3)

where ρ_{G} and ρ_{L}, are the phase densities and γ=U_{sd}/(U_{sG}+U_{sd}) is the relative liquid fraction in the gas core.

The gas core and liquid layer momentum balances are

$$\begin{matrix}{A}_{gc} ( \frac{dp}{dx} + {ρ}_{gc} g sin θ ) + {τ}_{f} {S}_{f} + {τ}_{ic} {S}_{ic} = 0 & ( 4 ) \\ {A}_{l} ( \frac{dp}{dx} + {ρ}_{l} g sin θ ) + {τ}_{l} {S}_{l} - {τ}_{i} {S}_{i} = 0 & ( 5 )\end{matrix}$$

where S_{f}=(D−2h)δ_{gc} is the interfacial perimeter between the gas core and the thin film; S_{ic}=(D−2h)sin δ_{gc} is the interfacial perimeter between the gas core and the liquid layer; Sₗ=Dδₗ is the wall wetted perimeter and Sᵢ=D sin δₗ is the interfacial perimeter between the liquid layer and the combined gas core and liquid film area. The corresponding mean shear stresses τ_{f}, τ_{ic}, τₗ and τᵢ are computed using the OLGA HD Stratified Flow Model, for example. Finally, g is the acceleration of gravity. Sᵢ−S_{ic} represents the length of the tiny contact region between the liquid layer and the liquid film, and we make the approximation that τ_{ic}≈τᵢ.

Eliminating the pressure gradient between the gas and liquid layer momentum balances gives the holdup equation:

εₗS_{f}τ_{f}−ε_{gc}Sₗτₗ+(ε_{gc}Sᵢ+εₗS_{ic})τᵢ (6)

−ε_{gc}εₗA(ρₗ−ρ_{gc})g sin θ=0

Adding the gas and liquid layer momentum balances gives the pressure drop

$$- \frac{dp}{dx} = \frac{1}{( {ε}_{gc} + {ε}_{l} )} [ \frac{{τ}_{f} {S}_{f}}{A} + \frac{{τ}_{l} {S}_{l}}{A} - \frac{{τ}_{i} ( {S}_{i} - {S}_{ic} )}{A} + ( {ε}_{gc} {ρ}_{gc} + {ε}_{l} {ρ}_{l} ) g sin θ ] \qquad ( 7 )$$

The annular stratified flow model is solved by iteration on the liquid wetted angle δₗ. The corresponding liquid layer area fraction is given by

$${ε}_{l} = \frac{1}{π} ( {δ}_{l} - \frac{1}{2} sin 2 {δ}_{l} ) \qquad ( 8 )$$

The liquid film area fraction is ε_{f}=1−εₗ−ε_{gc}, where the gas core area fraction is

$${ε}_{gc} = \frac{1}{π} ( {δ}_{gc} - \frac{1}{2} sin 2 {δ}_{gc} ) {( 1 - \frac{h}{R} )}^{2} \qquad ( 9 )$$

in which the gas core wetted angle δ_{gc} is related to the film wetted angle δ_{f}=π−δₗ and thickness h by

$${δ}_{gc} = acos ( \frac{cos {δ}_{f}}{1 - h / R} ) \qquad ( 10 )$$

The constraint −1≤cos δ_{f}/(1−h/R)≤1 secures the correct behaviour in the limits of purely annular flow and liquid-only flow, δ_{gc}→πand δ_{gc}→0 respectively.

The basic model to be considered here is generally a two-phase model. As described in below, three phase effects are accounted for by assuming homogeneous mixtures of oil and water in the liquid film and the liquid layer. Models are used to relate the water fractions in the film, in the droplet field and in the layer, and mixture models are used for the effective properties of the liquid. In the following sections, we consider the film thickness and effective roughness for given properties of the liquid in the film.

4. Film Thickness

Consider a liquid film with density ρ_{f}, viscosity μ_{f}, and thickness h. Assuming a linear velocity distribution u_{f}≈τ_{f}y/μ_{f}, and integrating over the film area A_{f} gives the film bulk velocity:

$${U}_{f} = \frac{2 {δ}_{f} D {τ}_{f}}{{ε}_{f} {μ}_{f} π} ( 1 - \frac{4}{3} \frac{h}{D} ) {( \frac{h}{D} )}^{2} \qquad ( 11 )$$

Neglecting higher order terms in h/D<<1 and reformulating, we obtain

$$h \approx \sqrt{\frac{{Re}_{f}}{2}} {δ}_{{μ}_{f}} \qquad ( 12 )$$

This expression shows that the film thickness is proportional to the viscous length scale of the liquid film δ_{μ}_{_{f}}=v_{f}/u_{f}*, where of u_{f}*=\sqrt{τ_{f}/ρ_{f}} is the film friction velocity. The proportionality depends on the film Reynolds number Re_{f}=D_{f}U_{f}/v_{f}, where D_{f}=4A_{f}/S_{f} and v_{f}=μ_{f}/ρ_{f}. Substituting the film superficial velocity U_{sf}=ε_{f}U_{f}, we also have Re_{f}=D(π/δ_{f})U_{sf}/v_{f}.

Assume that the film thickness is limited by the onset of turbulence at the interface, and model this by imposing an upper limit y⁺≤C₊ on the scaled film thickness y⁺=u_{f}*h/v_{f}, where we take C₊≈15. Equation (12) gives the relationship between the scaled film thickness and film Reynolds number y⁺≈\sqrt{Re_{f}/2}. Applying this, we obtain the corresponding upper limit for the film superficial velocity:

$${U}_{sf} \leq min [ {U}_{sL} , 2 {C}_{+}^{2} \frac{{δ}_{f} {v}_{f}}{π D} ] \qquad ( 13 )$$

where we have also included the limit given by the input liquid superficial velocity U_{sL}.

5. Effective Roughness

In previous annular flow models with low liquid loading, the effective film roughness k_{E} was considered approximately proportional to the film thickness, that is k_{E}∝h. Based on this, a reformulation of equation (12) gave the effective roughness for a viscous dominated film:

$$\frac{{k}_{E}}{{D}_{gc}} = 3.7 \cdot \frac{{C}_{μ} \sqrt{{Re}_{f}}}{\sqrt{{λ}_{μ}} {Re}_{i}} \qquad ( 14 )$$

where Reᵢ=\sqrt{ρ_{f}ρ_{gc}}U_{gc}D_{gc}/v_{f} is a two-phase Reynolds number. In some embodiments considered when developing the work underlying aspects of the invention, value C_{μ}≈0.17 by tuning the model against stratified annular flow data. Note that equations (12) and (14) imply that the effective roughness is related to the film height by k_{E}=3.7 C_{μ}h/2≈0.315 h.

The effective roughness model has been adapted to the annular stratified flow geometry by introducing the hydraulic diameter for the gas core:

$${D}_{gc} = \frac{4 {A}_{gc}}{{S}_{i c} + {S}_{f}} \qquad ( 15 )$$

In our previous work, the expression for surface tension dominated roughness was obtained by an energy argument:

$$\frac{{k}_{E}}{{D}_{gc}} = 3.7 \cdot \frac{{B}_{σ}}{{λ}_{σ} W {e}_{i}} \qquad ( 16 )$$

where Weᵢ=D_{gc}ρ_{gc}U_{gc}²/σ_{gf} is the Weber number, and σ_{gf} is the surface tension between the gas-core and the liquid film,. Biberg et al. (2017). To account for the variation in the liquid flow rate, we apply the correlation B_{σ}=C_{σ}Weₗ^{1/6} with Weₗ=D(π/δ_{f})ρ_{f}Uₛₗ²/σ_{gf} and C_{σ}≈0.16, based on the field data.

Applying von Kármán's friction law for hydraulic rough flow yields

$$\frac{1}{\sqrt{{λ}_{f}}} = - 2 {log}_{10} ( \frac{{k}_{E}}{3.7 {D}_{gc}} ) \qquad ( 17 )$$

based on the gas core hydraulic diameter D_{gc} to obtain reasonable approximations for the friction factors λ_{f}=λ_{μ} and λ_{f}=λ_{σ}. The resulting implicit equations are solved using the positive real branch of the Lambert function W(x). The corresponding approximate value for the film shear stress τ_{f} is given by

$${τ}_{f} \approx \frac{{λ}_{f}}{4} \frac{{ρ}_{gc} {U}_{gc}^{2}}{2} \qquad ( 18 )$$

The friction factors λ_{μ} and λ_{σ} are obtained using the hydraulic diameter concept, which implicitly assumes that the stratified gas-liquid interface has the same roughness as the liquid film on the pipe wall. This is of course generally not the case. However, these values are only used as reasonable approximations to obtain the effective film roughness; the full HD stratified flow model may be used to compute the final values for the shear stresses.

6. Gravity Effects

In the stratified annular flow, gravity tends to drain the liquid film from the pipe wall. The associated volumetric flux at the position where the pipe wall is vertical is

$${q}_{f} = \frac{{h}^{3}}{3 {μ}_{f}} ( {ρ}_{f} - {ρ}_{gc} ) g cos θ \qquad ( 19 )$$

The turbulence in the gas core opposes this effect by smoothing out differences in the (mean) film thickness h. This effect gives rise to a diffusive flux q′_{f} of liquid from regions where the film is thicker towards regions where the film is thinner.

To obtain a simple model, consider the diffusive flux to be composed of a velocity scale v and length scale l, that is q_{f}′∝vl. Thicker regions of the film tend to have a partly turbulent (buffer) layer on top of a viscous sub-layer closer to the pipe wall. The diffusive flux may be associated with the turbulence in the buffer layer and model the velocity scale as being proportional to the film friction velocity i.e. v∝\sqrt{τ_{f}/ρ_{f}}. For the length scale, the ratio of turbulent forces (as represented by τ_{f}) to buoyancy forces, taking l∝τ_{f}/[(ρ_{f}−ρ_{gc})g cos θ] gives

$${q}_{f}^{′} ∝ \frac{{τ}_{f}^{3 / 2}}{\sqrt{{ρ}_{f}} ( {ρ}_{f} - {ρ}_{gc} ) g cos θ} \qquad ( 20 )$$

Under steady conditions, the gravity and diffusion effects balance and the net flux is zero i.e.

q_{f}′+q_{f}=0 (21)

Those with skill in the art will appreciate, however, in certain conditions, the net flux may only be approaching zero where the gravity and diffusing effects are merely substantially in balance. Combining the equations and solving for the film thickness gives

$$h ∝ \frac{{μ}_{f}^{1 / 3} \sqrt{{τ}_{f}}}{{{ρ}_{f}^{1 / 6} [ ( {ρ}_{f} - {ρ}_{g c} ) g cos θ ]}^{2 / 3}} \qquad ( 22 )$$

Finally, assuming the effective roughness to be proportional to the film thickness k_{E}∝h, and introducing the friction factor for gravity-controlled flows using equation (18) with λ_{f}=λ_{g}, we obtain the corresponding expression for the relative effective film roughness

$$\frac{{k}_{E}}{{D}_{gc}} = 3.7 \cdot \frac{{C}_{g} F {r}^{2 / 3}}{{Re}_{i}^{1 / 3}} \sqrt{{λ}_{g}} \qquad ( 23 )$$

where Fr=ρ_{gc}U_{gc}²/[D_{gc}(ρ_{f}−ρ_{gc})g cos θ] is the densitometric Froude number squared. The constant was set to C_{g}≈0.04 using field data.

From this expression, it can be seen that the model predicts the relative effective roughness (and film thickness) for gravity-controlled flows to be given by a complex balance between viscous forces, turbulent forces and gravitational forces. The roughness decreases as gravity forces increase and increases as viscous forces increase, as in the friction-dominated case.

The friction factor for gravity-controlled flows λ_{g} is determined using von Kármán's friction law for hydraulic rough flows with λ_{f}=λ_{g}, which gives

$$\frac{1}{\sqrt{{λ}_{g}}} = - 2 {log}_{10} ( \frac{{C}_{g} {Fr}^{2 / 3}}{{Re}_{i}^{1 / 3}} \sqrt{{λ}_{g}} ) \qquad ( 24 )$$

The correct solution tends to zero as Fr^{2/3}/Reᵢ^{1/3}→0 and is given in terms of the negative real branch of the Lambert function W₋₁(x) on the interval 0<C_{g}Fr^{2/3}/Reᵢ^{1/3}<2/(e ln(10))≈0.3195, see, e.g., FIG. 3.

Once the friction factor for gravity-controlled flows is known, the corresponding effective relative roughness can be determined from equation (23) and (approximate) shear stress from equation (18).

For friction-dominated flow, the maximum of the viscous-dominated and surface tension-dominated film roughness may be chosen, as given by equations (14) and (16). Gravity-controlled films may be accounted for by taking the minimum of the resulting friction-dominated roughness and the gravity-controlled roughness, equation (23).

To obtain a complete model for stratified annular flow, the film bulk velocity or flow rate in the gravity-controlled regime, as represented by the corresponding film Reynolds number, may be calculated.

The effective roughness may be assumed to be proportional to the film thickness k_{E}∝h. Assuming the velocity distribution to be linear, the film thickness is given by equation (12). Applying equation (18) with λ_{f}=λ_{g} to represent the shear stress, gives an alternative expression for the relative effective roughness in gravity-controlled films:

$$\frac{{k}_{E}}{{D}_{gc}} = 3.7 \cdot \frac{{C}_{μ g} \sqrt{{Re}_{f}}}{\sqrt{{λ}_{g}} {Re}_{i}} \qquad ( 25 )$$

in which the film Reynolds number Re_{f} remains to be determined. This expression may be compared to the corresponding expressions for friction dominated films, equation (14), in which the film Reynolds number Re_{f} is given by the upper limit on the superficial velocity equation (13). We note that C_{μ,g} is not the same constant as C_{g} in equation (23). However, taking C_{μ,g} to be equal to C_{μ} in equation (14) gives h=2k_{E}/(3.7 C_{μ}) as for viscous dominated films, and secures that the film height remains continuous in the transition from gravity-controlled to viscous-dominated films. Finally, computing the shear stress for gravity-controlled films using equations (18) and (23) allows obtaining the film bulk velocity and Reynolds number by use of equation (11)

7. Three-Phase Flows

The basic model described above is generally a two-phase model. Three-phase flows are much more complex. A fully mechanistic model may call for detailed information about the distribution and conformation of the oil and aqueous phase (which we refer to as water for brevity) within the liquid film. Nevertheless, the present model may provide an approximate description of three-phase flow by modelling the liquid in the thin film and the layer as homogeneous oil-water mixtures, with apparent properties based on simple mixture models.

Assuming no-slip between the oil and water in the film, the water fraction in the film is given by

$${ω}_{f} = \frac{{U}_{saf}}{{U}_{shf} + {U}_{saf}} \qquad ( 26 )$$

where U_{shf} and U_{saf} are the oil and water superficial velocities in the liquid film. The corresponding liquid density is

ρ_{f}=(1−ω_{f})ρ_{H}+ω_{f}ρ_{A} (27)

where ρ_{H} and ρ_{A} are the phase densities of oil and water. The liquid film mixture viscosity may be modeled using the blending

μ_{f}=[(μ_{Ah})⁻ⁿ+(μ_{Ha})⁻ⁿ]^{-1/n} (28)

between the mixture viscosities for oil-continuous and water-continuous mixtures, where μ_{Ah} represents the viscosity of a water-in-oil mixture and and μ_{Ha} represents the viscosity of an oil-in-water mixture at the same water fraction. A model for the mixture viscosities may be employed, with relative viscosity 100 at dispersed phase concentration 0.765, and set the blending parameter to n=4.

The blending (equation (28)) predicts the inversion point ω_{I} to be at the crossing point of the viscosity curves for oil-continuous and water-continuous dispersions, μ_{Ah}(ω_{I})=μ_{Ha}(ω_{I}). The predicted inversion point ω_{I} is applied in the model for the surface tension between the gas and the liquid mixture. In the oil-continuous case, there cannot be water droplets on the interface, so the surface tension value is that for gas and oil. For the water-continuous case, oil droplets can spread on the interface. This effect may be represented by a linear interpolation between the gas-oil and gas-water surface tension values. Assuming that σ_{GA}>σ_{GH}, this gives

$${σ}_{gf} = max [ {σ}_{gh} , \frac{{σ}_{G H} ( 1 - {ω}_{f} ) + {σ}_{G A} ( {ω}_{f} - {ω}_{I} )}{1 - {ω}_{I}} ] \qquad ( 29 )$$

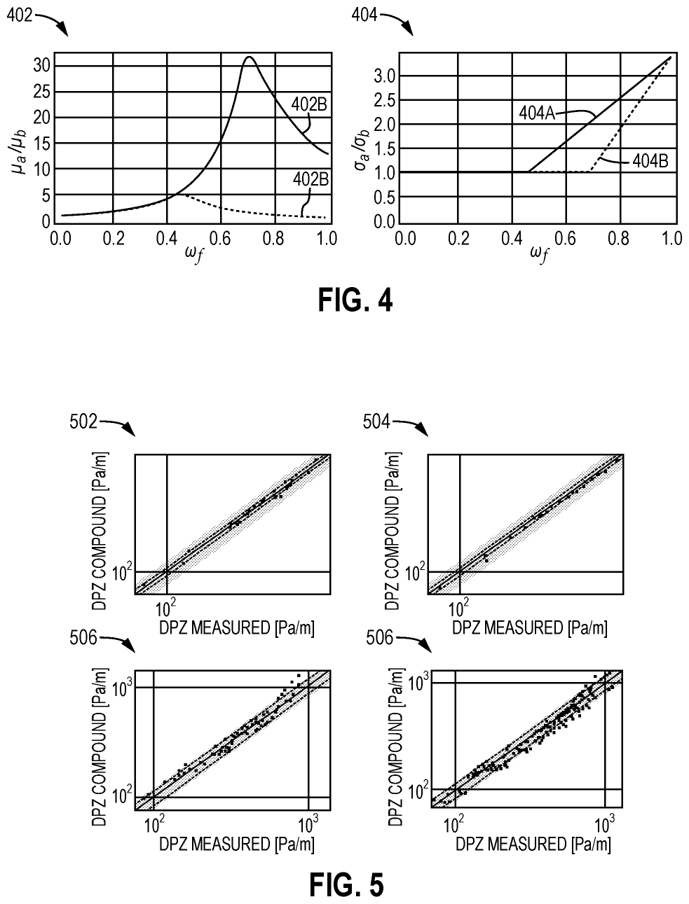

Plots of the mixture viscosity model (FIG. 4 402) and surface tension model (FIG. 4 404) for pure water and water with added glycerol are given, where pure water plot lines are designated as 402a and 404a, while water with added glycerol plot lines are designed as 402b and 404b.

For axisymmetric vertical annular flow, the liquids are expected to be well-mixed, so the water fraction in the film can be taken equal to the input water cut, ω_{f}=WC. However, for inclined or horizontal flow, this approximation is valid only for situations where gravitational effects are too weak to make a stratified liquid layer at the bottom of the pipe, which may occur at very high gas rates, very low liquid rates and/or small deviations from vertical flow.

For annular stratified flows, the liquid phases are distributed among the stratified layer at the bottom of the pipe, the droplet field, and the annular film. The differences in physical properties (density, viscosity and surface tension) between the oil and aqueous phases can lead to an enrichment of the aqueous phase in the stratified liquid layer and of the oil phase in the annular film. This may be accounted for by incorporating a simple model for the relationship between the water fraction in the stratified layer and the water fraction in the thin film, mediated by the droplet field.

Independent droplet fields for the oil and water phases may be assumed, with droplet sizes determined by a Hinze-Kolmogorov model, and exponential scale heights determined by a balance of turbulent diffusion and gravitational settling of the droplets. A difference in scale heights for the oil and water droplet distributions leads to a gradual reduction in the water fraction with height in the pipe cross section. Then an averaging process is used to determine a representative value for the water fraction in the thin annular film, and its relation to the water fraction in the stratified layer. This is coupled with an overall mass balance to determine the water fractions in the layer and the film. The effective liquid properties in the stratified layer are determined using the same models as for the thin film.

8. Data Comparisons

Although the model presented above is quite general and provides a description of the thin liquid film in various types of stratified annular flows, the model has the greatest influence on predictions for situations with low liquid loading, so we focus comparisons on the data gathered in the recent 2017 campaign at the Tiller loop in Norway.

The experiments targeted two- and three-phase annular-stratified flows with low liquid loading. The test section was an 8-in pipe, 100 m long and inclined at 2.5° above the horizontal. All experiments were made with nitrogen at 60 bara for the gas and Exxsol D60 for the hydrocarbon liquid. The aqueous phase was either water or water with glycerol added to increase the viscosity, simulating the effect of MEG. Two different temperatures were used for the experiments with glycerol, giving two different values for the liquid-liquid viscosity ratio.

FIG. 5 shows a summary of the overall performance of the new model through a comparison of predicted and measured values of the pressure drop (DPZ). In these plots, the grey shaded zone indicates the traditional ±20% error bounds, while the dashed lines indicate the P80 error bounds, which contain 80% of the data.

In the top two panels of FIGS. 5 (502 and 504, respectively), it can be seen that the model performs very well, for two phase gas-oil and gas-water data; the discrepancies between the predicted and measured values are of the same order as the experimental uncertainty. For the gas-water-glycerol data, shown in the lower left panel (FIG. 5 506), the discrepancies are somewhat larger. This is attributed, in part, to greater uncertainty in the liquid viscosity caused by small variations in the concentration of glycerol.

The performance of the model for three-phase flows is shown in the lower right panel (FIG. 5 508), which includes the two-and three-phase data; somewhat larger discrepancies are seen, but the overall performance is acceptable. In addition to the uncertainty in the viscosity for the glycerol-water mixture, there may be additional experimental uncertainty due to difficulties in ensuring repeatability of the three phase experiments, but most of the discrepancy may be attributed to the simplified three-phase model.

In the experiments, the liquid content in the pipe was determined using narrow beam gamma densitometers aligned with the vertical pipe diameter. It is possible to estimate corresponding holdup values using different assumptions about the liquid distribution (e.g. perfectly stratified flow, symmetric annular flow, perfectly homogeneous flow), but none of these assumptions is justified in the present context, where the liquid is distributed between a stratified layer, an annular film and a droplet field. Instead, we use the model to calculate the line fraction of liquid on a vertical diameter and compare directly with the measured line fraction.

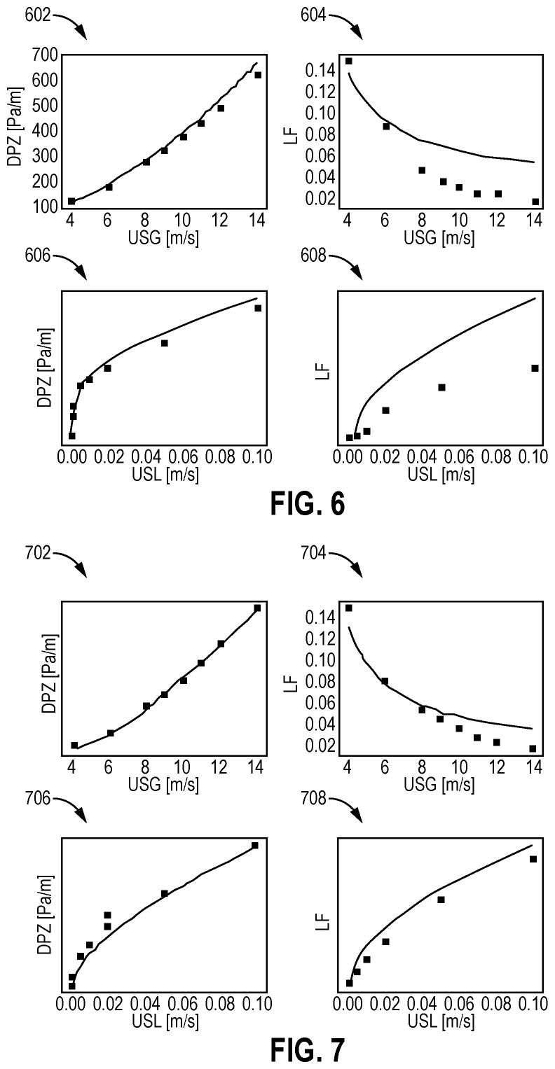

FIG. 6 shows the trends in predictions of the pressure drop (left column, i.e., 602 and 606, respectively) and liquid line fraction (right column, i.e., 604 and 608, respectively) for a two-phase gas oil flow. The upper row shows the trend with superficial gas velocity, while the lower row shows the trend with superficial liquid velocity, for both the model (solid line) and the data (symbols). It can be seen that the model captures the trends in pressure drop very well, with quantitative precision, and also gives good qualitative predictions for the liquid line fraction, with a consistent over-prediction at higher gas velocities.

FIG. 7 (i.e., 702, 704, 706, and 708) shows the trend plots for two-phase gas-water data in the same format as FIG. 6. In these plots, the model is seen to capture the trends in the data very well, both qualitatively and quantitatively. The slight over-prediction of the liquid line fraction at high values of superficial gas velocity is likely due to the simplified geometry of the model shown in FIG. 2. The model incorporates a perfectly flat interface for the stratified layer, but in reality, this interface is likely to be curved on average.

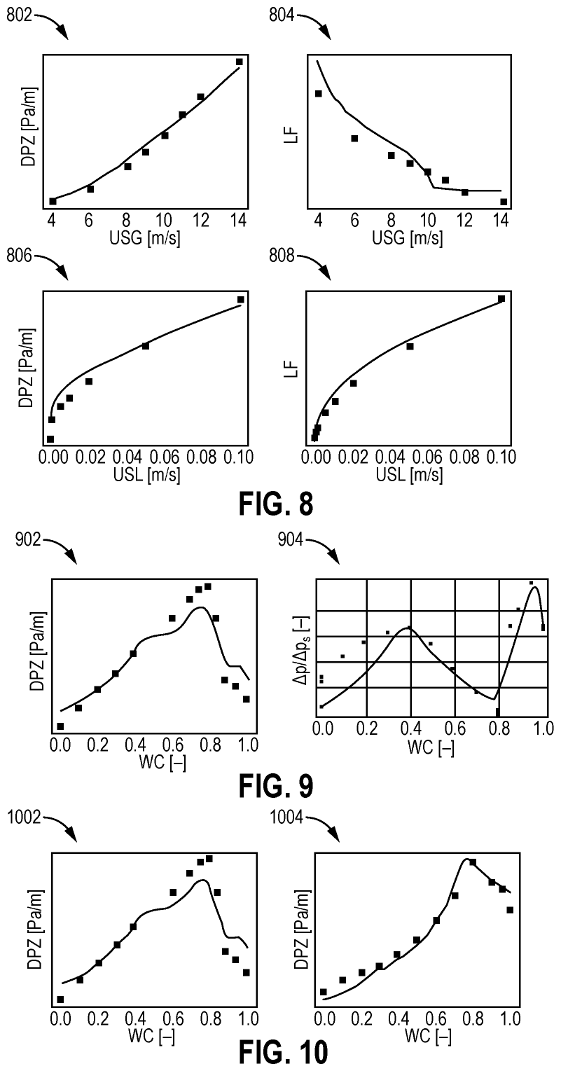

FIG. 8 (i.e., 802, 804, 806, and 808) shows plots in the same format as FIGS. 6 and 7, this time for two-phase flow of gas with a mixture of water and glycerol having a viscosity of approximately 17 mPa. The model again matches the trends in the data very well, indicating that the dependence of the film roughness on liquid viscosity is captured by the dimensionless groups that form the basis of the model. The upper panels show a low liquid loading case, and the slight kink in the trend lines corresponds to the transitions from stratified-annular to purely annular flow, where the stratified liquid layer disappears.

FIG. 9 shows trend plots of the pressure gradient against the water cut for three-phase gas oil-water flow. The left panel 902 shows the trend for near horizontal flow (in an 8-in pipe), while the right panel 904 shows the trend for vertical flow (in a 4-in pipe) as a basis for comparison. The data for near horizontal flow show a single strong peak, reminiscent of phase inversion, at a water cut of around 0.8. The model captures this peak reasonably well and includes a weaker peak or shoulder at a water cut of around 0.45.

This illustrates the way that the model handles the distribution of oil and water between the stratified liquid layer and the thin annular film. The figure corresponds to a moderately low liquid loading, where most of the liquid flows in the stratified layer at the bottom of the pipe. The stratified layer therefore has a water fraction close to the input water cut, and the small peak near WC=0.45 corresponds to phase inversion in this layer.

In contrast, the water fraction in the thin annular film is lower than the input water cut and does not reach the phase inversion value of around 0.45 until the input water cut is around 0.8. This figure corresponds to a high gas flow rate, so the frictional contribution from the film roughness is dominant. The peak at WC=0.8, corresponding to phase inversion in the film is therefore the dominant one.

The right panel 904 in FIG. 9 shows a similar trend plot for vertical flow. In this case, there is no stratified layer, so the water fraction in the film is close to the input water cut, and there is a strong phase inversion peak around WC=0.4. This dataset shows a second strong peak around WC=0.9 that we previously attributed to the effects of surface tension and surface elasticity. This second peak may be caused by the sudden onset of entrainment of gas bubbles in the liquid film, also leading to a surface roughness controlled by surface tension.

FIG. 10 shows further trend plots for three phase flows. Again, the trend is shown as a function of water cut varying from zero (two-phase gas-oil flow) to unity (two-phase gas-water flow). The left hand plot 1002 shows data for gas-oil-water flows (repeating the left panel 802 of FIG. 8), and the right hand plot 1004 shows data for gas-oil-water glycerol flow.

As described previously, the data in the left-hand plot 1002 correspond to a moderately low liquid loading, so most of the liquid flows in the stratified layer, leading to a double hump in the model curve. The data in the right-hand plot 1004 correspond to a much higher viscosity aqueous phase (approximately 55 mPa), and a lower liquid flow rate, so that most or all the liquid flows in the thin annular film. In this case, the fraction of aqueous phase in the thin film is similar to the input water cut, so that phase inversion occurs at an input water cut around 0.8, as predicted by the double Pal and Rhodes model.

The occurrence of a peak in the pressure drop for WC around 0.8 in both plots is a coincidence. In the left-hand plot 1002, it is caused by non-uniform distribution of the water and oil. In this plot the left-hand side 1002 of the curve is more convex, corresponding to the double hump in the model. In the right-hand plot 1004, the peak is a natural consequence of phase inversion with a near-uniform distribution of the oil and aqueous phases. This is supported by the concave shape of the data and the model on the left-hand side of the curve.

9. Conclusion

The hurricane-like conditions occurring at high flow rates in gas condensate pipe-lines give rise to a thin liquid film spreading around the pipe wall driven by the violent turbulent fluctuations. The wavy structure on the film is associated with a large increase in the effective wall roughness, which in many cases leads to a substantial increase in the pressure drop.

The effective film roughness increases with the effective liquid viscosity, which becomes particularly high in three-phase flows where the-oil water mixture has a high mixture viscosity near the phase inversion point. This effect is further compounded by adding highly viscous hydrate inhibitors such as MEG to the water phase.

At low flow rates, gravity effects cause the liquid film to drain from the pipe wall and reduce the effective film roughness. The model disclosed herein captures these effects and improves pressure drop predictions for low liquid loading flows.

Three-phase effects are accounted for in an approximate way, by applying the two-phase model with effective properties for the oil-water mixture. When simple models for the mixture viscosity and surface tension are used, comparison with data for three-phase flow confirms the functional form of the roughness model.

The present model may be tailored for near horizontal flows with low liquid loading, since these flows are strongly influenced by the apparent roughness of the thin liquid film on the pipe wall. However, the model may be used in other situations where a thin liquid film forms at the pipe wall, including stratified gas-liquid flows at high rates in near-horizontal, inclined, and vertical pipes. As such, it forms a component of a model for the continuous transition from stratified to annular flow that occurs as pipe inclination is increased from horizontal to vertical.

10. Example Flowchart of the Method

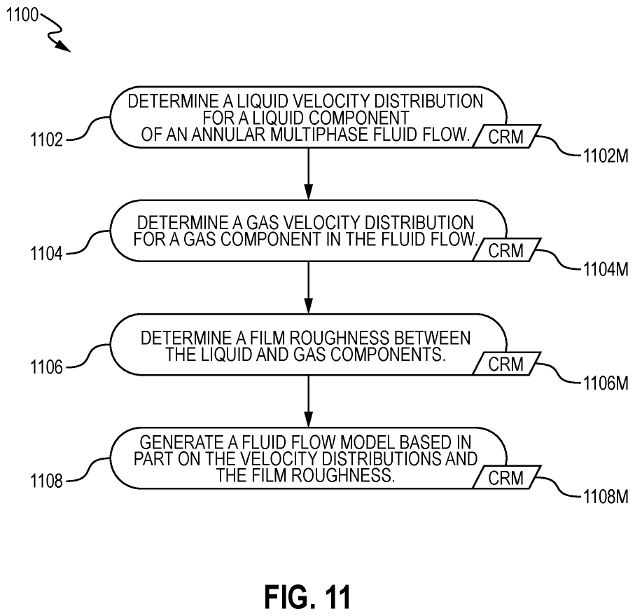

FIG. 11 illustrates a flowchart of a method 1100 for modelling annular fluid flow, according to an embodiment. The method 1100 may proceed by determining a liquid velocity distribution profile of a liquid component in an annular, multiphase fluid flow, as at 1102. The method 1100 may also include determining a gas velocity distribution profile of a gas component in the annular, multiphase fluid flow, as at 1104. The method 1100 may include determining film roughness between the liquid and gas components with the fluid flow have an asymmetric phase distribution, as at 1106. For example, the film roughness accounts for gravity effects in a horizontal or inclined flow direction. Specifically, the degree of asymmetry may be determined by balancing gravity forces and turbulent stresses so that the asymmetry tends to increase as the deviation of the pipe from vertical increases, as the gas flow rate decreases, or as the liquid flow rate increases. The method 1100 may then include generating (e.g., updating or newly building) a fluid flow model based at least in part on the liquid and gas velocity distributions and the film roughness, as at 1108.

11. Example Computing Environment

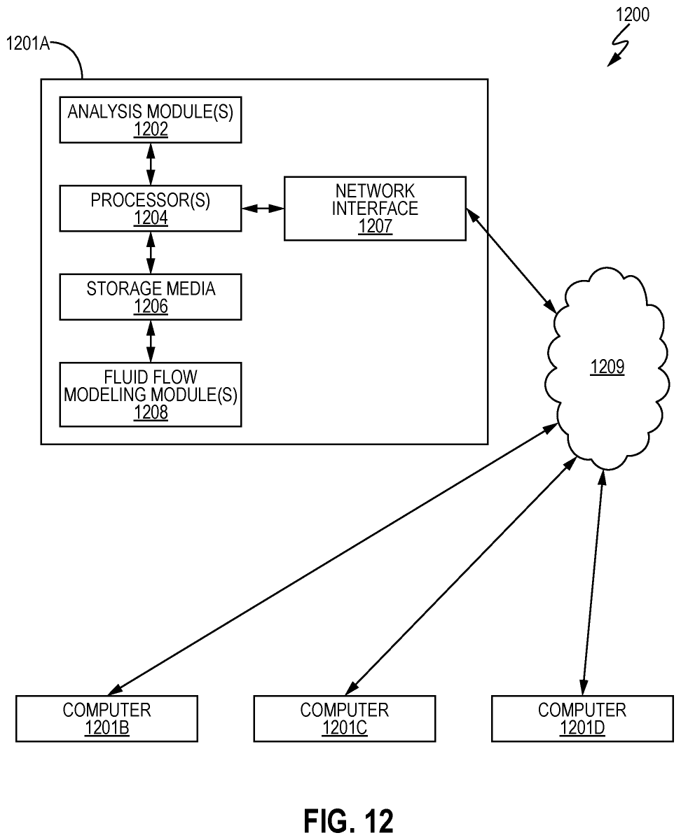

In some embodiments, the methods of the present disclosure may be executed by a computing system. FIG. 12 illustrates an example of such a computing system 1200, in accordance with some embodiments. The computing system 1200 may include a computer or computer system 1201A, which may be an individual computer system 1201A or an arrangement of distributed computer systems. The computer system 1201A includes one or more analysis modules 1202 that are configured to perform various tasks according to some embodiments, such as one or more methods disclosed herein. To perform these various tasks, the analysis module 602 executes independently, or in coordination with, one or more processors 1204, which is (or are) connected to one or more storage media 1206. The processor(s) 1204 is (or are) also connected to a network interface 1207 to allow the computer system 1201A to communicate over a data network 1209 with one or more additional computer systems and/or computing systems, such as 1201B, 1201C, and/or 1201D (note that computer systems 1201B, 1201C and/or 1201D may or may not share the same architecture as computer system 1201A, and may be located in different physical locations, e.g., computer systems 1201A and 1201B may be located in a processing facility, while in communication with one or more computer systems such as 1201C and/or 1201D that are located in one or more data centers, and/or located in varying countries on different continents).

A processor may include a microprocessor, microcontroller, processor module or subsystem, programmable integrated circuit, programmable gate array, or another control or computing device.

The storage media 1206 may be implemented as one or more computer-readable or machine-readable storage media. Note that while in the example embodiment of FIG. 12 storage media 1206 is depicted as within computer system 1201A, in some embodiments, storage media 1206 may be distributed within and/or across multiple internal and/or external enclosures of computing system 1201A and/or additional computing systems. Storage media 1206 may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories, magnetic disks such as fixed, floppy and removable disks, other magnetic media including tape, optical media such as compact disks (CDs) or digital video disks (DVDs), BLURAY® disks, or other types of optical storage, or other types of storage devices. Note that the instructions discussed above may be provided on one computer-readable or machine-readable storage medium, or may be provided on multiple computer-readable or machine-readable storage media distributed in a large system having possibly plural nodes. Such computer-readable or machine-readable storage medium or media is (are) considered to be part of an article (or article of manufacture). An article or article of manufacture may refer to any manufactured single component or multiple components. The storage medium or media may be located either in the machine running the machine-readable instructions, or located at a remote site from which machine-readable instructions may be downloaded over a network for execution.

In some embodiments, computing system 1200 contains one or more flow modelling module(s) 1208. In the example of computing system 1200, computer system 1201A includes the flow modelling module 1208. In some embodiments, a single flow modelling module may be used to perform some aspects of one or more embodiments of the methods disclosed herein. In other embodiments, a plurality of flow modelling modules may be used to perform some aspects of methods herein.

It should be appreciated that computing system 1200 is merely one example of a computing system, and that computing system 1200 may have more or fewer components than shown, may combine additional components not depicted in the example embodiment of FIG. 12, and/or computing system 1200 may have a different configuration or arrangement of the components depicted in FIG. 12. The various components shown in FIG. 12 may be implemented in hardware, software, or a combination of both hardware and software, including one or more signal processing and/or application specific integrated circuits.

Further, the steps in the processing methods described herein may be implemented by running one or more functional modules in information processing apparatus such as general purpose processors or application specific chips, such as ASICs, FPGAs, PLDs, or other appropriate devices. These modules, combinations of these modules, and/or their combination with general hardware are included within the scope of the present disclosure.

Computational interpretations, models, and/or other interpretation aids may be refined in an iterative fashion; this concept is applicable to the methods discussed herein. This may include use of feedback loops executed on an algorithmic basis, such as at a computing device (e.g., computing system 1200, FIG. 12), and/or through manual control by a user who may make determinations regarding whether a given step, action, template, model, or set of curves has become sufficiently accurate for the evaluation of the subsurface three-dimensional geologic formation under consideration.

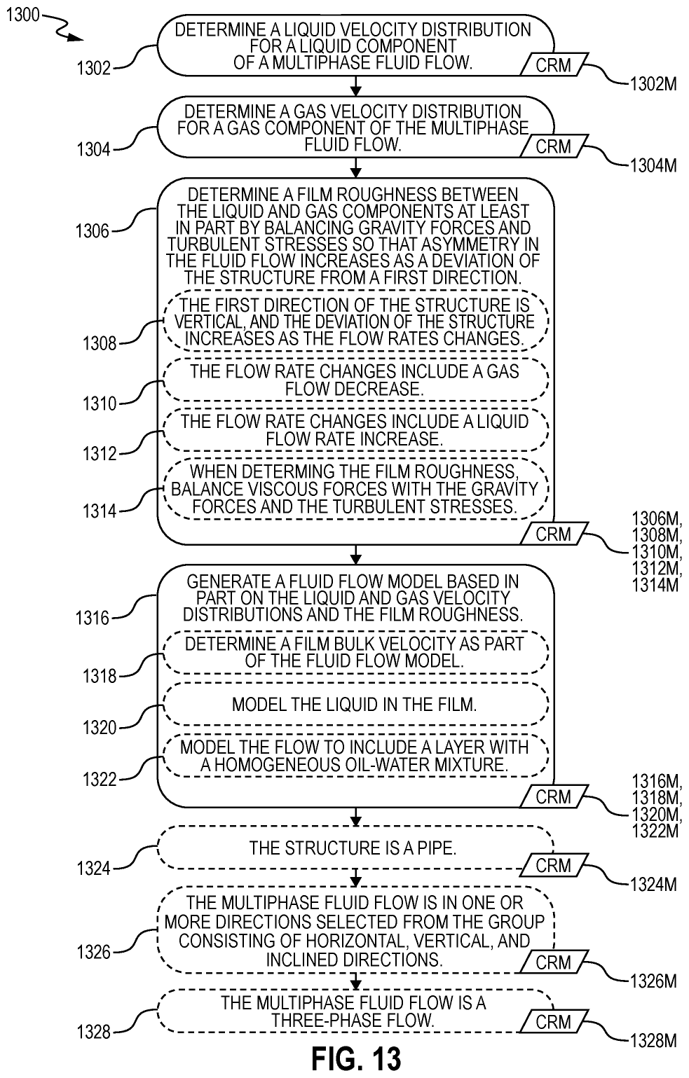

Attention is now directed to FIG. 13, which provides a method 1300 for modelling an annular multiphase fluid flow in a structure, in accordance with some embodiments.

Attention is now directed to FIG. 13, which provides a method 1300 for modelling an annular multiphase fluid flow in a structure, in accordance with some embodiments.

The method 1300 includes determining 1302 a liquid velocity distribution for a liquid component the multiphase fluid flow (see also, e.g., FIG. 11, 1100, 1102).

The method 1300 includes determining 1304 a gas velocity distribution for a gas component of the multiphase fluid flow (see also, e.g., FIG. 11, 1100, 1104).

The method 1300 includes determining 1306 a film roughness between the liquid and gas components at least in part by balancing gravity forces and turbulent stresses so that asymmetry in the fluid flow increases as a deviation of the structure from a first direction (see also, e.g., FIG. 11, 1100, 1106). For example, the structure may be a pipe in a pipeline transporting an oil/gas/water mixture, and the direction of the structure may be inclined. Indeed, in some embodiments, the first direction of the structure is vertical, and the deviation of the structure increases as the flow rate changes (see FIG. 13, 1308).

In some embodiments, the flow rate changes include a gas flow rate decrease (see FIG. 13, 1310). In some embodiments, the flow rate changes include a liquid flow rate increase. (see FIG. 13, 1312) In some embodiments, determining the film roughness further includes balancing viscous forces with the gravity forces and the turbulent stresses. (see FIG. 13, 1314).

The method 1300 includes generating 1316 a fluid flow model based in part on the liquid and gas velocity distributions and the film roughness (see also, e.g., FIG. 11, 1100, 1108).

In some embodiments, a film bulk velocity is determined as part of the fluid flow model (see FIG. 13, 1318). In some embodiments, the fluid flow model is generated in part by modelling the liquid in the film (see FIG. 13, 1320). In some embodiments, the fluid flow model is generated in part by modelling the flow to include a layer with a homogeneous oil-water mixture (see FIG. 13, 1322).

In some embodiments, the structure is a pipe (see FIG. 13, 1324). Those with skill in the art will appreciate, however, that the techniques disclosed herein, including method 1300, may be used to model multiphase fluid flow in many types of structures, including without limitation, other equipment such as valves, risers, tubes, and any other structure through which multiphase fluid flow may occur.

In some embodiments, the multiphase fluid flow is in one or more directions selected from the group consisting of horizontal, vertical, and inclined directions (see FIG. 13, 1326).

In some embodiments, the multiphase fluid flow is a three-phase flow (see FIG. 13, 1328).

Those with skill in the art will appreciate that the workflows described above, including methods 1100 and 1300 may be practiced in many environments, including without limitation oil & gas applications, as well as any context in which multiphase fluid flow in a structure may need to be modelled.

Moreover, methods 1100 and 1300 are shown as including various computer-readable storage medium (CRM) blocks 1102m, 1104m, 1106m, 1108m, 1302m, 1304m, 1306m, 1308m, 1310m, 1312m, 1314m, 1316m, 1318m, 1320m, 1322m, 1324m, 1326m, and 1328m that can include processor-executable instructions that can instruct a computing system, to perform one or more of the actions described with respect to their respective methods.

The foregoing description, for purpose of explanation, has been described with reference to specific embodiments. However, the illustrative discussions above are not intended to be exhaustive or limiting to the precise forms disclosed. Many modifications and variations are possible in view of the above teachings. Moreover, the order in which the elements of the methods described herein are illustrate and described may be re-arranged, and/or two or more elements may occur simultaneously. The embodiments were chosen and described in order to best explain the principals of the disclosure and its practical applications, to thereby enable others skilled in the art to best utilize the disclosed embodiments and various embodiments with various modifications as are suited to the particular use contemplated.

what is claimed is:

1. A method for modelling an annular multiphase fluid flow in a structure, comprising:
determining a liquid velocity distribution for a liquid component of the multiphase fluid flow;
determining a gas velocity distribution for a gas component of the multiphase fluid flow;
determining a film roughness between the liquid and gas components at least in part by balancing gravity forces and turbulent stresses so that asymmetry in the fluid flow increases as a deviation of the structure from a first direction; and
generating a fluid flow model based in part on the liquid and gas velocity distributions and the film roughness.

2. The method of claim 1, wherein the structure is a pipe.

3. The method of claim 1, wherein the multiphase fluid flow is in an inclined direction.

4. The method of claim 1, wherein the multiphase fluid flow is in a vertical direction.

5. The method of claim 1, wherein the multiphase fluid flow is in a horizontal direction.

6. The method of claim 1, wherein the multiphase fluid flow is in one or more directions selected from the group consisting of horizontal, vertical, and inclined directions.

7. The method of claim 1, wherein the first direction is vertical, and the deviation increases as the flow rate changes.

8. The method of claim 7, wherein the flow rate changes include a gas flow rate decrease.

9. The method of claim 7, wherein the flow rate changes include a liquid flow rate increase.

10. The method of claim 1, wherein determining the film roughness further includes balancing viscous forces with the gravity forces and the turbulent stresses.

11. The method of claim 1, further comprising determining a film bulk velocity as part of the fluid flow model.

12. The method of claim 1, wherein the multiphase fluid flow is a three-phase flow.

13. The method of claim 12, wherein the fluid flow model is generated in part by modelling the liquid in the film.

14. The method of claim 12, wherein the fluid flow model is generated in part by modelling the flow to include a layer with a homogeneous oil-water mixture.

15. A computing system, comprising:
one or more processors; and
a memory system comprising one or more non-transitory computer-readable media storing instructions that, when executed by at least one of the one or more processors, cause the computing system to perform operations, the operations comprising the method of claim 1.

16. A non-transitory computer-readable medium storing instructions that, when executed by one or more processors of a computing system, cause the computing system to perform operations, the operations comprising the method of claim 1.
